(19) United States
(12) Patent Application Publication
(10) Pub. No.: US 2014/0062207 A1
(43) Pub. Date: Mar. 6, 2014

(54) ELECTRONIC SYSTEM, ELECTRONIC DEVICE AND POWER MANAGEMENT METHOD

(71) Applicant: ACER INCORPORATED, New Taipei City (TW)

(72) Inventor: Chi-Nan LU, New Taipei City (TW)

(73) Assignee: ACER INCORPORATED, New Taipei City (TW)

(21) Appl. No.: 13/839,412

(22) Filed: Mar. 15, 2013

(30) Foreign Application Priority Data
Sep. 4, 2012 (TW) 101132123

(51) Int. Cl. H02J 7/00

(52) U.S. Cl. CPC H02J 7/0068
USPC 307/80

(57) ABSTRACT

An electronic system is provided. The electronic system is powered by a constant power adapter and has a core system, a rechargeable battery, a charger, and a control unit. The core system is arranged to control operations of the electronics device, and the charger is arranged to convert the power provided by the constant power adapter into a charge voltage. The control unit is arranged to detect whether the capacity of the rechargeable battery exceeds a first predetermined value when the requirement power of the electronics device exceeds the maximum output power of the constant power adapter, and to enable the rechargeable battery and the constant power adapter to power the core system at the same time when the capacity of the rechargeable battery exceeds the first predetermined value.

### CROSS REFERENCE TO RELATED APPLICATION

This Application claims priority of Taiwan Patent Application No. 101132123, filed on Sep. 4, 2012, the entirety of which is incorporated by reference herein.

### BACKGROUND OF THE INVENTION

1. Field of the Invention

The present invention relates to an electronic system, and in particular, to an electronic system powered by a constant power adapter.

2. Description of the Related Art

FIG.1 illustrates the principle of the power manager of a traditional notebook. When the voltage difference Vcs generated by the output current IO of the power adapter flowing via the current detector approaches to a second voltage Vcs1, it means that the requirement power (system load) PS of the notebook is approaching the rated output power P1 of the power adapter. It should be noted that the system load PA of the power adapter is equivalent to the requirement power PS of the notebook and the output voltage VO of the power adapter is a constant value. At this time, the power manager stops charging the battery or reduces the charging current to make the voltage difference Vcs of the current detector lower than a second voltage Vcs1, such that the requirement power PS of the notebook is lower than the rated output power P1 of the power adapter.

If reducing the charge current of the battery or shutting down the battery charger cannot decrease the voltage on the current detector to be lower than the second voltage Vcs1, the power manager sends a system power management signal to the ?, such that the current consumption of the CPU or the other devices of the system is forced to decease until the voltage difference Vcs on the current detector is lower than the second voltage Vcs1, thereby preventing shutting down of the power adapter caused by the over-load.

FIG.2 illustrates the operation characteristics of the power adapter in a traditional notebook. When the output current IO of the power adapter is larger than an over-load line (OLL), the over-load timer (i.e. watch dog timer) begins a counting process. When the counting value of the over-load timer is larger than a predetermined value PV, the power adapter is shut down. As shown in FIG. 2, at time t1 to t2, the output current IO is below the over-load line, such that the over-load timer does not begin the counting process. At time t3 to t4, the output current IO exceeds the over-load line, such that the over-load timer starts the counting process until the output current IO is below the over-load line. The counting value of the over-load timer is below the predetermined value PV, and thus the power adapter does not shut down. At time t5 to t6, the output current IO exceeds the over-load line, such that the over-load timer begins the counting process, wherein when the counting value of the over-load timer approaches the predetermined value PV at time t6, the power adapter shuts down (i.e., the output voltage VO is decreased to zero).

In view of the operation characteristics and system specifications of the notebook, a sudden increase for the power requirement of the notebook usually occurs for just a short period. For example, instant reading/writing of a particular program may result in an increase in the system requirement power for a short period of time. Traditionally, in order to avoid and reduce overloading of the power adapter, the rated output power (90 watts) of the selected power adapter is to be higher than the requirement power (for example, 65 watts) of the system operated in normal operation. However, most of the time, the system does not need such a high requirement power which will lead to poor performance. Furthermore, the size of the higher rated power adapter is usually larger than the size of the lower rated power adapter, which hinders downsizing of higher rated power adapter designs.

### BRIEF SUMMARY OF INVENTION

A detailed description is given in the following embodiments with reference to the accompanying drawings.

An embodiment of an electronic system is provided. The electronic system is powered by a constant power adapter and has a core system, a rechargeable battery, a charger, and a control unit. The core system is arranged to control operations of the electronics device, and the charger is arranged to convert the power provided by the constant power adapter into a charge voltage. The control unit is arranged to detect whether the capacity of the rechargeable battery exceeds a first predetermined value when the requirement power of the electronics device exceeds the maximum output power of the constant power adapter, and to enable the rechargeable battery and the constant power adapter to power the core system at the same time when the capacity of the rechargeable battery exceeds the first predetermined value.

An embodiment of a power management method suitable for an electronic device powered by a constant power adapter is provided, wherein the electronic device comprises a core system, a rechargeable battery, a charger, and a control unit. The power management method comprises: identifying whether a requirement power of the electronic device exceeds a maximum output power of the constant power adapter; detecting whether a capacity of the rechargeable battery exceeds a first predetermined value, when the requirement power of the electronic device exceeds the maximum output power of the constant power adapter; and enabling the rechargeable battery and the constant power adapter to power the core system at the same time when the capacity of the rechargeable battery exceeds the first predetermined value.

An embodiment of an electronic device is provided. The electronic device is powered by a constant power adapter. The electronic device has a core system, a rechargeable battery, a charger, and a control unit. The core system is arranged to control operations of the electronics device. The control unit is arranged to detect whether the capacity of the rechargeable battery exceeds a predetermined value when a requirement power of the electronics device exceeds a maximum output power of the constant power adapter, and to enable the rechargeable battery and the constant power adapter to power the core system at the same time when the capacity of the rechargeable battery exceeds the first predetermined value.

### BRIEF DESCRIPTION OF DRAWINGS

The present invention can be more fully understood by reading the subsequent detailed description and examples with references made to the accompanying drawings, wherein:

FIG. 1 is a diagram showing the principle of the power manager of a traditional notebook;

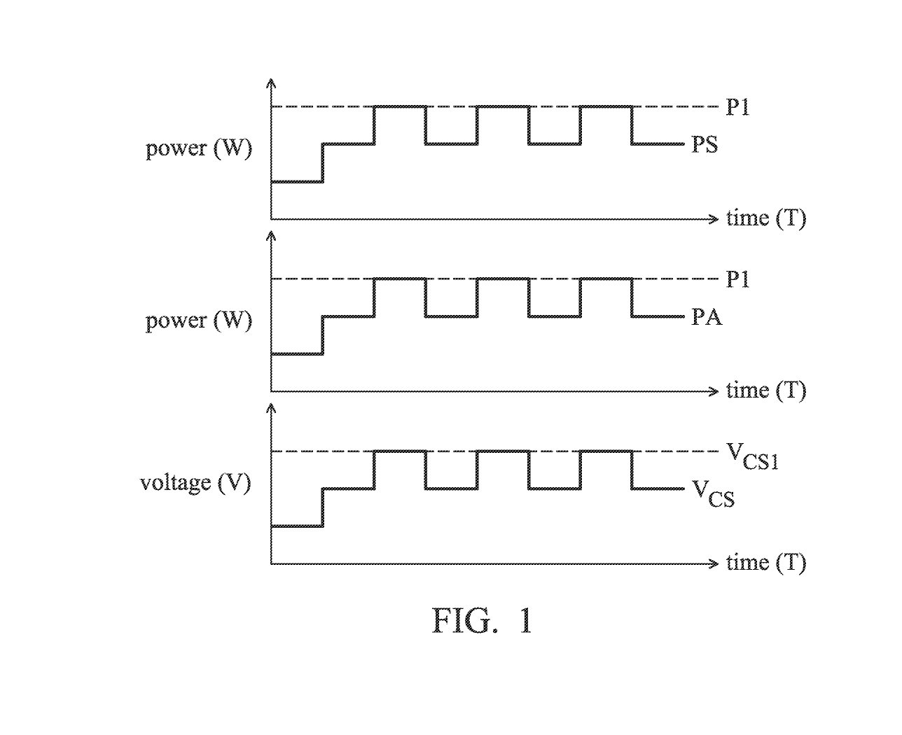

FIG. 2 is another diagram showing the operation characteristics of the power adapter in a traditional notebook;

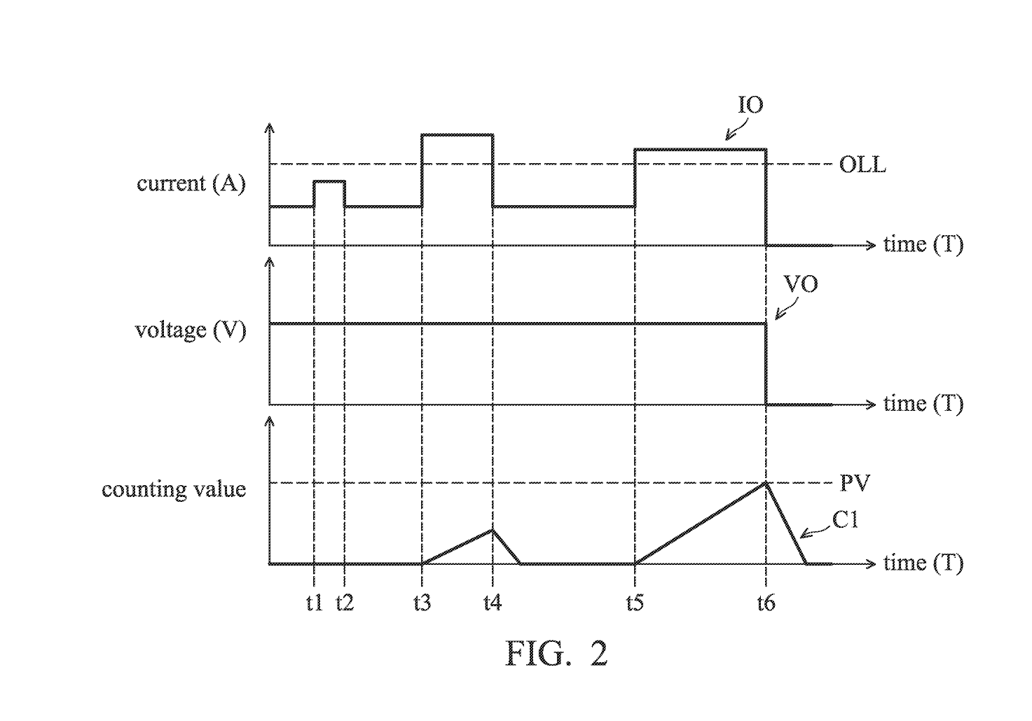

FIG. 3 is a diagram showing an electronic device of the invention;

FIG. 4A is another diagram showing an electronic device of the invention;

FIG. 4B is another diagram showing an electronic device of the invention;

FIG. 5A is another diagram showing an electronic device of the invention;

FIG. 5B is another diagram showing an electronic device of the invention;

FIGS. 6(a) to 6(d) are the timing diagrams of an electronic device of the invention; and

FIG. 7 is another diagram showing the operation characteristics of the constant power adapter.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

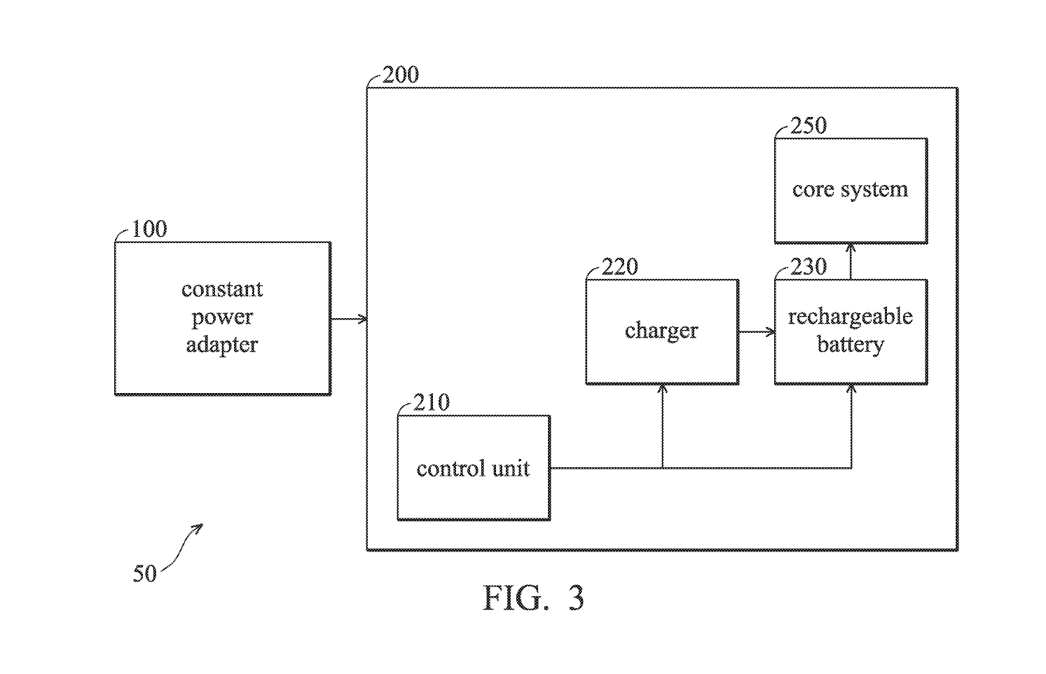

FIG. 3 is a schematic diagram showing an electronic system in an embodiment of the invention. As shown in FIG. 3, the electronic system 50 comprises a constant power adapter 100 and an electronic device 200, wherein the electronic device 200 comprises a control unit 210, a charger 220, a rechargeable battery 230 and a core system 250. For example, the core system 250 includes a processing unit, a memory unit, a storage device, an input device, an output device, and a communication device, wherein all of them can be connected by buses. In other words, the electronic device 200 can be a computer. Moreover, those skilled in the art will understand that some embodiments of the electronic device 200 may be practiced with other computer system configurations, including hand-held devices, multiprocessor-based, microprocessor-based or programmable consumer electronics, network PCs, minicomputers, mainframe computers, and the like. For example, the electronic device 200 may be microprocessor-based or programmable consumer electronics, such as hand-held phones, projector, monitors, PDAs, digital recorder devices, digital music player, etc. The processing unit can include a central-processing unit (CPU) or a plurality of processing units related to a parallel processing environment. The memory unit can include read only memories (ROM), flash ROMs and/or random access memories (RAM) for storing program codes executed by the processing unit. Generally, program codes include routines, programs, objects, components or Web Services, etc, arranged to control the operation of the electronic device 200.

In the embodiments of the invention, the constant power adapter 100 is configured to convert an AC power (Mains) into a DC power to power the charger 220 and/or the core system 250. The electronic device 200 is coupled to the constant power adapter 100, and powered by the constant power adapter 100 or the rechargeable battery 220. The electronic device 200 drives the core system 250 and/or charges the rechargeable battery 220, according to the power (i.e. voltage and/or current) provided by the constant power adapter 100.

The control unit 210 is configured to detect whether the capacity of the rechargeable battery 230 exceeds a first predetermined value when a requirement power of the electronic device exceeds a maximum output power of the constant power adapter, and to enable the rechargeable battery 230 and the constant power adapter 100 to power the core system 250 at the same time when the capacity of the rechargeable battery 230 exceeds the first predetermined value. In an embodiment, the requirement power of the electronic device 200 is the system load of the electronic device 200 or the system load of the core system 250, but it is not limited thereto. Furthermore, the maximum output power of the constant power adapter 100 can also be the rated output power of the constant power adapter 100. For example, the control unit 210 can be an embedded controller, an 8051 microprocessor or a control chip, but it is not limited thereto. In embodiments of the invention, the requirement power of the electronic device exceeds the maximum output power of the constant power adapter because of the power requirement for instantly accessing the programs or powering on the system, but it is not limited thereto.

For example, the control unit 210 detects the output current of the constant power adapter, generates a first voltage corresponding to the output current and determines that the requirement power of the electronic device 200 exceeds the maximum output power provided by the constant power adapter 100 when the first voltage exceeds a second voltage. When the requirement power of the electronic device 200 exceeds the maximum output power provided by the constant power adapter 100, the control unit 210 first controls the charger 220 to decrease or to shut down the charge current of the rechargeable battery 230. If the requirement power of the electronic device 200 still exceeds the maximum output power provided by the constant power adapter 100, the capacity of the rechargeable battery 230 is detected. If the detected capacity of the rechargeable battery 230 exceeds a first predetermined value, the control unit 210 enables the rechargeable battery 230 and the constant power adapter 100 to power the core system at the same time.

Furthermore, if the requirement power of the electronic device 200 still exceeds the summation of the maximum output power provided by the constant power adapter 100 and the power of the rechargeable battery 230, the control unit 210 delivers a power management signal to the core system 250 such that the core system 250 is forced to decrease the requirement power until the requirement power of the electronic device 200 is lower than the maximum output power provided by the constant power adapter 100. For example, the core system 250 decreases the system performance according to the power management signal delivered by the control unit 210 (i.e., core system 250 decreases operation frequency and/or the operation voltage of the CPU, but it is not limited thereto).

In an embodiment, after the rechargeable battery 230 and the constant power adapter 100 power the core system 230 at the same time, the control unit 210 enables the rechargeable battery 230 to stop powering the core system 250, if the capacity of the rechargeable battery 230 is lower than the first predetermined value. If the requirement power of the electronic device 200 still exceeds the maximum output power of the constant power adapter 100, the control unit 210 delivers the power management signal to the core system, such that the core system 250 is forced to decrease the requirement power. For example, the first predetermined value is 80% of the total capacity of the rechargeable battery 230, but it is not limited thereto. In another embodiment, the first predetermined value can be 70%, 90%, 85%, or 60% of the total capacity of the rechargeable battery 230, but it is not limited thereto.

In another embodiment, after the rechargeable battery 230 and the constant power adapter 100 power the core system 250 at the same time, the rechargeable battery 230 continues to provide power to the core system 250 when the capacity of the rechargeable battery 230 is lower than the first predetermined value, until the capacity of the rechargeable battery 230 is lower than a second predetermined value, such that the control unit 210 enables the rechargeable battery 230 to stop powering the core system 230. If the requirement power of the electronic device 200 still exceeds the maximum output power of the constant power adapter 100, the control unit 210 delivers the power management signal to the core system such that the core system 250 is forced to decrease the requirement power. In the present embodiment, the second predetermined value is lower than the first predetermined value. For example, the first predetermined value is 80% of the total capacity of the rechargeable battery 230 and the second predetermined value is 70% of the total capacity of the rechargeable battery 230, but it is not limited thereto. In another embodiment, the first predetermined value is between 80% and 70% of the total capacity of the rechargeable battery 230 and the second predetermined value is between 69% and 50% of the total capacity of the rechargeable battery 230, but it is not limited thereto. Thus, the frequent switching of the charging and discharging of the rechargeable battery 230, which occurs when the remaining power of the rechargeable battery 230 is close to the first predetermined value, can be prevented by setting the first predetermined value and the second predetermined value. Also, the lifespan of the rechargeable battery 230 can be extended.

In the invention, because the output power of the constant power adapter 100 is a constant value, the output voltage of the constant power adapter is decreased when the requirement power of the electronic device 200 is increased (i.e., increasing the current consumption). The control unit 210 drives the constant power adapter 100 and the rechargeable battery 230 to power the core system 250 in parallel when the output voltage of the constant power adapter approaches the voltage of the rechargeable battery 230. In an embodiment, the rechargeable battery 230 can be a smart battery having a gauge IC configured to detect the capacity of the rechargeable battery 230. Additionally, the control unit 210, charger 220 and the rechargeable battery 230 are connected by a bus (I2C bus or SM bus), such that the capacity of the rechargeable battery 230 can be detected by the control unit 210 continually.

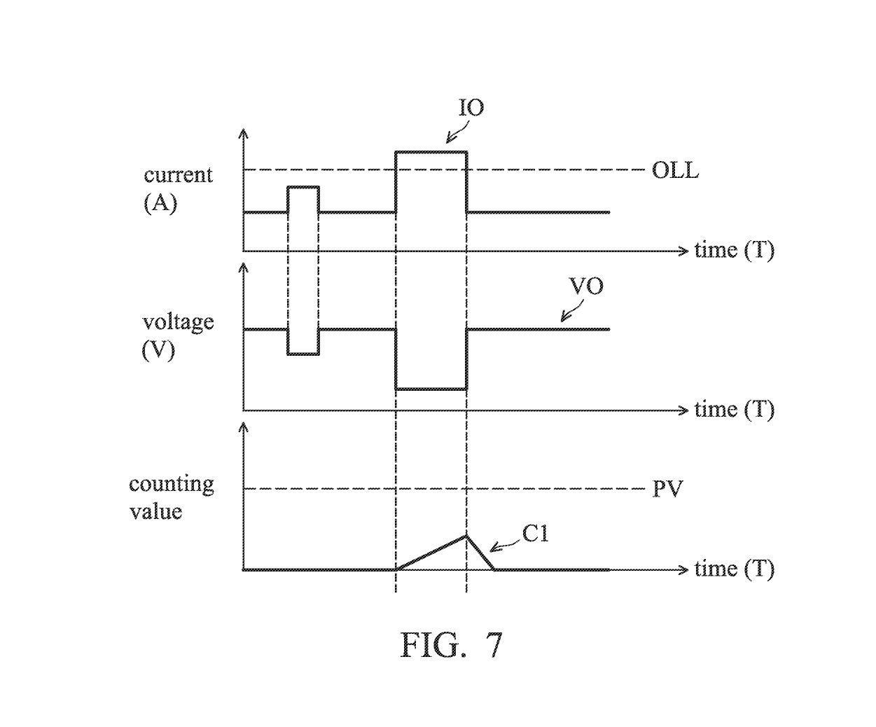

FIG. 7 illustrates the operation characteristics of the constant power adapter of the present invention. Because the output power of the constant power adapter 100 is a constant value, the output current IO of the constant power adapter 100 is increased and the output voltage VO is decreased when the requirement power (system load) of the electronic device 200 is increased. The over-load timer counts when the output current IO exceeds an over-load line OLL. The constant power adapter 100 is shut down if the counting value C1 exceeds the predetermined value PV.

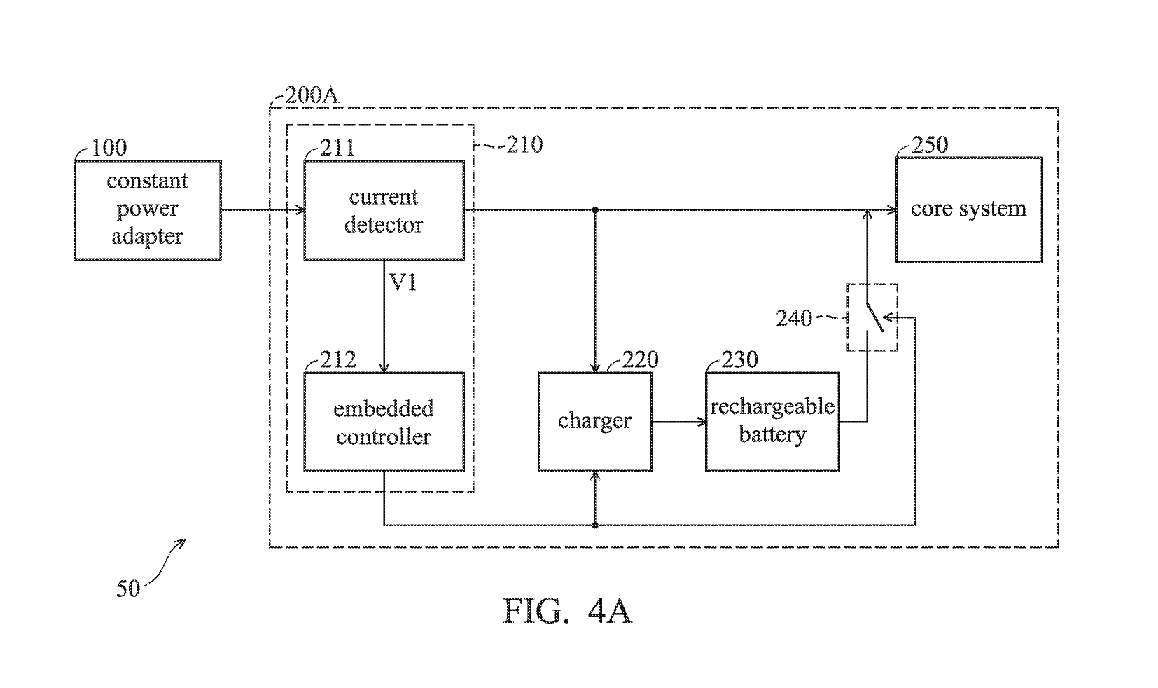

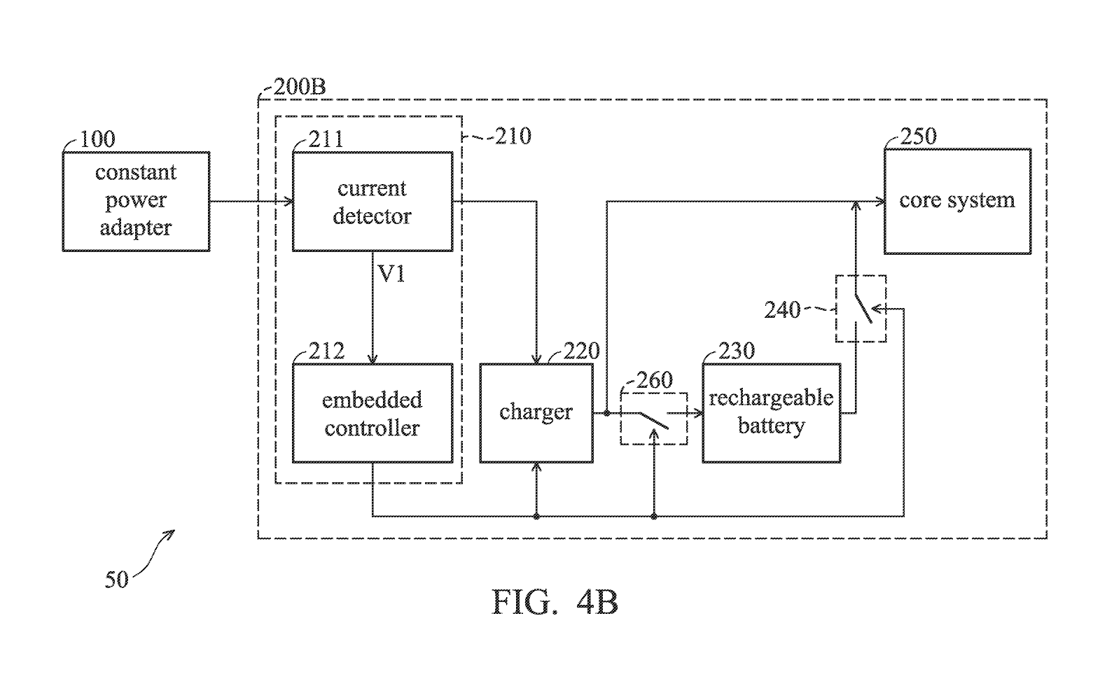

FIG. 4A is a schematic diagram showing an electronic system in an embodiment of the invention. As shown in FIG. 4A, the electronic system 50 comprises the constant power adapter 100 and an electronic device 200A, wherein the electronic device 200A comprises a control unit 210, a charger 220, a rechargeable battery 230, a switch 240 and a core system 250. The control unit 210 comprises a current detector 211 and an embedded controller 212.

The current detector 211 is configured to detect the output current provided to the electronic device 200A, generate a first voltage V1 according to the output current and output the first voltage V1 to the embedded controller 212, wherein the output current is supplied by the constant power adapter 100. The embedded controller 212 executes a corresponding control according to the first voltage V1. For example, when the first voltage V1 generated by the current flowing via the current detector 211 exceeds a second voltage of the embedded controller 212, if the charger 220 is powering the rechargeable battery 230, the embedded controller 212 outputs a control signal to the charger 220 such that the charger 220 decreases the charge current of the rechargeable battery 230 or the charger 220 is powered off.

Furthermore, the capacity of the rechargeable battery 230 is also detected by the embedded controller 212. After powering off the charger 220, if the first voltage V1 still exceeds the second voltage and the capacity of the rechargeable battery 230 exceeds the first predetermined value, the embedded controller 212 outputs a control signal to turn on the switch 240 such that the rechargeable battery 230 and the constant power adapter 100 power the core system 250 at the same time.

When the rechargeable battery 230 and the constant power adapter 100 power the core system at the same time, the embedded controller 212 delivers the power management signal to the core system 250 if the first voltage V1 still exceeds the second voltage, such that the electronic devices decreases the requirement power. For example, the requirement power of the electronic device 200 can be decreased by decreasing the operation speed of the CPU.

If the first voltage V1 generated by the current detector 211 is lower than the second voltage and the charger 220 does not power the rechargeable battery 230, it means that the requirement power of the electronic device 200A is lower than the maximum output power of the constant power adapter. The embedded controller 212 identifies whether the capacity of the rechargeable battery 220 is full. If not, the embedded controller 212 outputs the control signal to enable the charger 220 to power the rechargeable battery 230.

In another embodiment, if the first voltage V1 generated by the current detector 211 is smaller than the second voltage and the rechargeable battery 230 also powers the core system 250, it means that the requirement power of the electronic device 200A is lower than the summation of the output power of the constant power adapter and the rechargeable battery 230. When the rechargeable battery 230 does not power the core system 250, whether the output power of the constant power adapter 100 is sufficient for the core system 250 is determined If the output power of the constant power adapter 100 is sufficient for the core system 250, the rechargeable battery 230 stops powering the core system 250. Conversely, if the output power of the constant power adapter 100 is insufficient for the core system 250, the rechargeable battery 230 continually powers the core system 250. When the rechargeable battery 230 does not power the core system 250, the embedded controller 212 identifies whether the capacity of the rechargeable battery 230 is full, and delivers a control signal to enable the charger 220 to charge the rechargeable battery 230 if the capacity of the rechargeable battery 230 is not full.

FIG. 4B is another schematic diagram showing an electronic system in an embodiment of the invention. As shown in FIG. 4B, the electronic system 200B is similar to the electronic device 200A of FIG. 4. The difference is that the electronic device 200B includes a switch 260 and the core system is powered by the constant power adapter 100 via the charger 220. For the description of the same elements of the electronic device 200B and the electronic device 200A, please refer to the description in the FIG. 4A, and thus details thereof are omitted for brevity. In the present embodiment, the charger 220 is configured to convert the power (the outputted DC voltage) output by the constant power adapter 100 into a charge power (i.e. a charge voltage), and the charge power is supplied to the rechargeable battery 230 and/or the core system 250. In addition, the switch 240 and the switch 260 are controlled, respectively, by a first control signal and a second control signal output by the embedded controller 212.

For example, when the first voltage V1 generated by the current flowing via the current detector 211 exceeds a second voltage of the embedded controller 212, it means that the requirement power of the electronic device 200 exceeds the maximum output power of the constant power adapter. If the charger 220 is powering the rechargeable battery 230, the embedded controller 212 outputs the second control signal to the switch 260 such that the charger 220 stops powering the rechargeable battery 230.

Furthermore, the capacity of the rechargeable battery 230 can also be detected by the embedded controller 212. If charging the rechargeable battery 230 is stopped, the first voltage V1 is still exceeding the second voltage and the capacity of the rechargeable battery 230 exceeds the first predetermined value, thus, the embedded controller 212 delivers the control signal to turn on the switch 240 such that the rechargeable battery 230 and the charger 250 power the core system 250 at the same time.

If the first voltage V1 is still larger than the second voltage and the rechargeable battery 230 and the charger 250 powers the core system 250 at the same time, the embedded controller 212 delivers the power management signal to the core systems 250 such that the electronic device 200B is forced to decrease the requirement power. For example, the requirement power of the electronic device 200 can be decreased by decreasing the operation speed of the CPU, but it is not limited thereto.

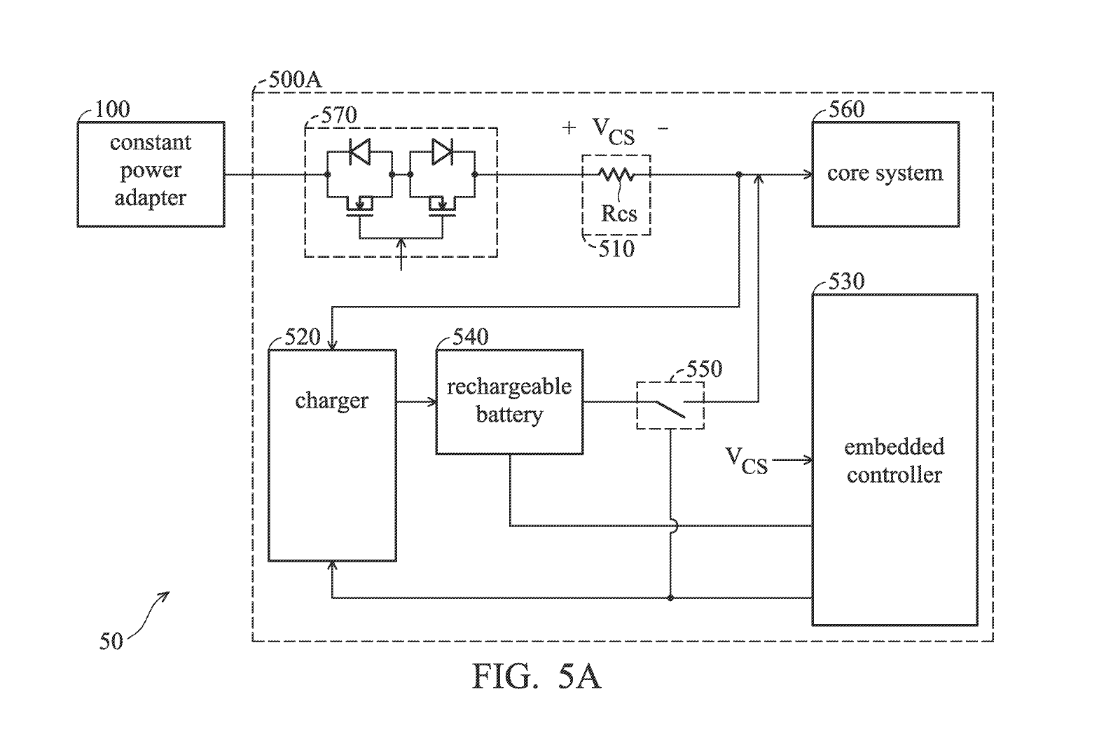

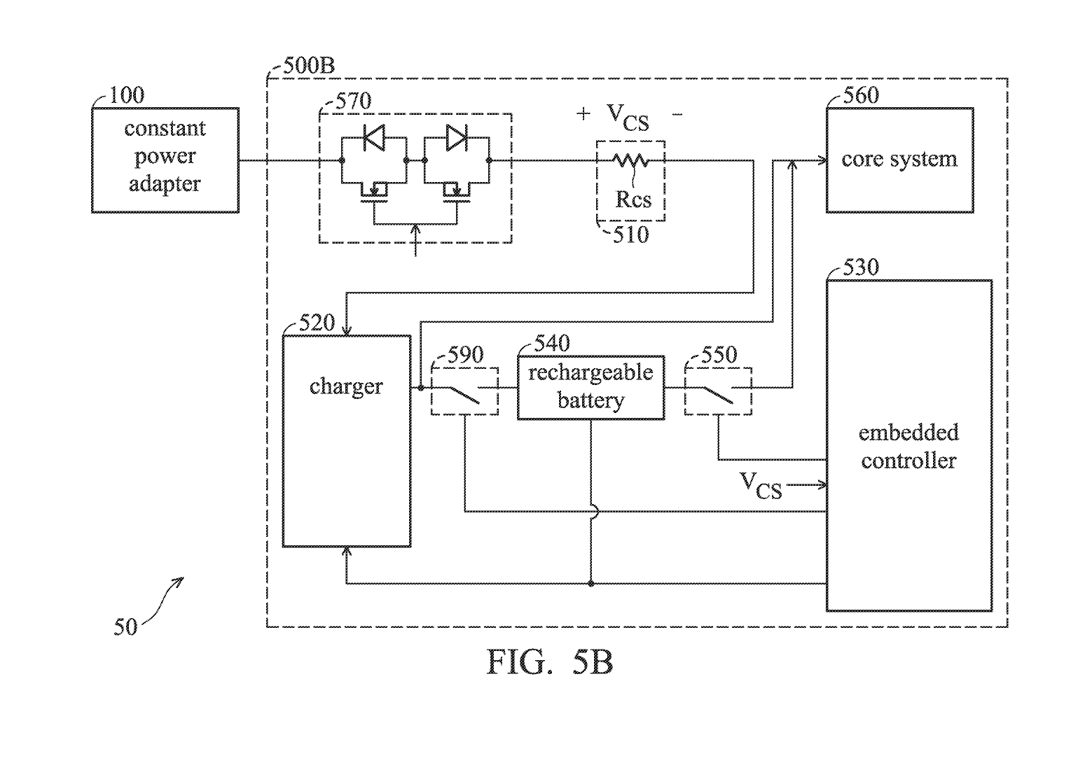

FIG. 5A is another schematic diagram showing an electronic system in an embodiment of the invention. As shown in FIG. 5A, the electronic system 50 comprises a constant power adapter 100 and an electronic device 500A, wherein the electronic device 500A comprises a soft start element 570, a core system 560, a switch 550, a chargeable battery 540, an embedded controller 530, a charger 520, and a current detector 510. The soft start element 570 is coupled to the constant power adapter 100, and the soft start element 570 is controlled by the core system 560 such that the output current of the constant power adapter 100 flows into the current detector 510.

The current detector 510 has a resistance Rcs. When the output current provided by the constant power adapter 100 flows via the resistance Rcs, the voltage difference Vcs is generated on both ends of the resistance Rcs. The voltage difference Vcs is output to the embedded controller 530, and the embedded controller 530 operates the corresponding control according to the voltage difference Vcs. In the present embodiment, the voltage difference Vcs can be the first voltage of the embodiments of the FIG.3, FIG.4A, and FIG. 4B.

For example, when the requirement power of the electronic device 500A exceeds the maximum output power of the constant power adapter 100, the voltage difference Vcs caused by the resistance Rcs exceeds the second voltage of the embedded controller 530. If the charger 520 is powering the rechargeable battery 540, the embedded controller 530 outputs a control signal to the charger 520 such that the charger 520 decreases the charge current or powers off the charger 520. Furthermore, the capacity of the rechargeable battery 540 can also be detected by the embedded controller 530.

After powering off the charger, if the first voltage V1 still exceeds the second voltage and the capacity of the rechargeable battery 540 exceeds the first predetermined value, the embedded controller 212 outputs the first control signal to turn on the switch 550, such that the rechargeable battery 540 and the constant power adapter 100 powers the core system 560 at the same time. If the voltage difference Vcs still exceeds the second voltage and the rechargeable battery 540 and the constant power adapter 100 powers the core system 560 at the same time, the embedded controller 530 delivers the power management signal to the core system 560 such that the electronic device 500A decreases the requirement power. For example, the requirement power of the electronic device 500A can be decreased by decreasing the operation speed of the CPU, but it is not limited thereto.

FIG. 5B is another schematic diagram showing an electronic system in an embodiment of the invention. As shown in FIG. 5B, the electronic system 500B is similar to the electronic device 500A of FIG. 5A. The difference is that the electronic device 500B further comprises a switch 590 and the core system 560 is powered by the constant power adapter 100 via the charger 520. For the description of the same elements of the electronic device 500B and the electronic device 500A, please refer to the description of the FIG. 5A, and thus details thereof are omitted for brevity. In the present embodiment, the charger 520 is arranged to convert the power (the outputted DC voltage) output by the constant power adapter 100 to a charge power, and the charge power is delivered to the rechargeable battery 540 and/or the core system 560. In addition, the switch 550 and the switch 590 are respectively controlled by a first control signal and a second control signal output by the embedded controller 530. The switch 590 is configured to turn off the charge current flowing to the rechargeable battery 540.

For example, the voltage difference Vcs generated by the resistance Rcs exceeds the second voltage in the embedded controller 530 when the requirement power of the electronic device 500B exceeds the maximum output power of the constant power adapter 100. If the charger 520 is charging the rechargeable battery 540, the embedded controller 530 outputs a second control signal to the switch 590 to enable the charger 520 to stop powering the rechargeable battery 540. Furthermore, the capacity of the rechargeable battery 540 can also be detected by the embedded controller 530.

After powering off the charger, if the first voltage V1 still exceeds the second voltage and the capacity of the rechargeable battery 540 exceeds the first predetermined value, the embedded controller 212 outputs the first control signal to turn on the switch 550, such that the rechargeable battery 540 and the constant power adapter 100 power the core system 560 at the same time. Then, if the voltage difference Vcs still exceeds the second voltage, the embedded controller 530 delivers the power management signal to the core system 560 such that the electronic device 500B decreases the requirement power. For example, the requirement power of the electronic device 500B can be decreased by decreasing the operation speed of the CPU, but it is not limited thereto.

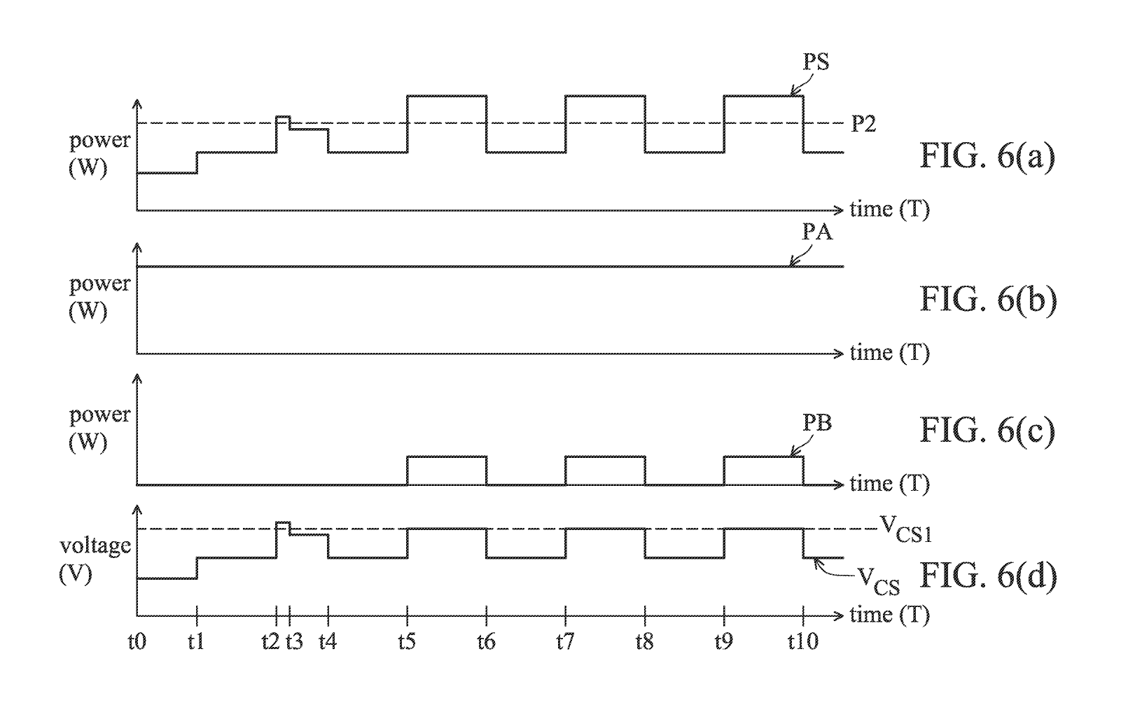

FIG. 6(a) to FIG. 6(d) are the timing diagrams of the electronic device 500A of FIG. 5. FIG. 6(a) illustrates the requirement power (system load) of the electronic device 500A. FIG. 6(b) illustrates the output power PA of the constant power adapter. FIG. 6(c) illustrates the power PB supplied by the rechargeable battery 540. FIG. 6(d) illustrates the voltage difference Vcs on the resistance Rcs. As shown in FIG. 6(a) to FIG. 6(b), at time t0 to t2, the requirement power PS (i.e. system load) of the electronic device 500A is lower than the output power PA of the constant power adapter. The embedded controller 530 determines whether the capacity of the rechargeable battery 540 is saturated (i.e., full) and, if not, the rechargeable battery 540 can be charged by the charger 520.

At time t2 to t3, the requirement power (the system load) PS of the electronic apparatus 500A exceeds the rated output power P2 of the constant power adapter 100. At this time, the voltage difference Vcs on the resistance Rcs exceeds the second voltage Vcs1 of the embedded controller 530, and thus, the embedded controller 530 delivers control signals at time t3 to enable the charger 520 to stop charging the rechargeable battery 540. In this way, the requirement power (the system load) PS of the electronic device 500A decreases at time t3 to t4, and the voltage difference Vcs on the current detector 510 is also lower than the second voltages Vcs1. At time t4 to t5, the requirement power (the system load) PS of the electronic device 500A is lower than the rated output power P2 of the constant power adapter 100.

At time t5 to t6, the requirement power (the system load) PS of the electronic device 500A exceeds the rated output power P2 of the constant power adapter 100, and the capacity of the rechargeable battery 540 is determined by the embedded controller 530. In the present embodiment, the capacity of the rechargeable battery 540 exceeds the first predetermined value, and thus the switch 550 is turned off by the embedded controller 530, and the rechargeable battery 540 and the constant power adapter 100 powers the core system 560 at the same time.

In another embodiment, after the core system 560 is powered by the rechargeable battery 540, if the capacity of the rechargeable battery 540 is lower than a first predetermined value (i.e. the minimum value of a predetermined capacity), the embedded controller 530 enables the rechargeable battery 540 to stop powering the core system 560. The embedded controller 530 further delivers the power management signal to the core system 560 to decrease the current consumption of the CPU of the core system 560 or the current consumption of the other devices until the voltage difference Vcs on the resistance Rcs is lower than the second voltage Vcs1.

At time t6 to t10, the operation of the embedded controller 530 is the same as the time t4 to t6, and thus details thereof are omitted for briefly. In some embodiments, the power management of the core system is implemented by the south/north bridge chip. In some embodiments, the power management of the core system is implemented by the embedded controller 530.

After the charger 520 stops powering the rechargeable battery 540 or decreases the charge current provided to the rechargeable battery 540, if the requirement power of the electronic device 500A still exceeds the rated power P2 of the constant power adapter 100, the embedded controller 530 uses the rechargeable battery 540 to power the core system 560 rather than deliver the power management signal to the core system to decrease the performance of the electronic device immediately.

Because the sudden increase of power of the electric device is usually for a short period of time (such as the instant reading/writing of a particular program resulting in the system requirement power to increase, the electronic device of the invention does not decrease its performance due to the instantaneous power issue. Furthermore, because the instantaneous power issue can be overcome by the power supplied by the rechargeable battery 540, the rated power of the constant power adapter 100 is required to satisfy the requirement for power for normal operation of the electronic device 500A.

Generally, a higher output power adapter is selected for overcoming the instantaneous power issue in traditional notebooks. However, most of the time the system does not require such high power, such that the efficiency of the power adapter is poor. On the contrary, the performance of the power adapter of the invention is better than the traditional power adapter. Furthermore, the lower output power means that the size is smaller than the size of the high output power adapter, such that designs can be lighter and smaller.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic system, comprising:
a constant power adapter; and
an electronic device, powered by the constant power adapter, the electronic device comprising:
a core system, configured to control operations of the electronic device;
a rechargeable battery;
a charger, configured to convert power provided by the constant power adapter into a charge power; and
a control unit, configured to detect whether a capacity of the rechargeable battery exceeds a first predetermined value when a requirement power of the electronic device exceeds a maximum output power of the constant power adapter, and to enable the rechargeable battery and the constant power adapter to power the core system at the same time when the capacity of the rechargeable battery exceeds the first predetermined value.

2. The electronic system as claimed in claim 1, wherein the control unit is configured to detect an output current which is provided to the electronic device, generate a first voltage corresponding to the output current, and determine that the requirement power exceeds the maximum output power when the first voltage exceeds a second voltage, wherein the output current is supplied by the constant power adapter.

3. The electronic system as claimed in claim 1, further comprising:
a first switch, coupled between the rechargeable battery and the core system, and configured to supply power of the rechargeable battery to the core system, according to a first control signal of the control unit when the requirement power exceeds the maximum output power.

4. The electronic system as claimed in claim 1, wherein the control unit further comprises:
a current detector, configured to detect an output current of the electronic device, and generate a first voltage corresponding to the output voltage, wherein the output current is supplied by the constant power adapter; and
an embedded controller, configured to identify that the requirement power exceeds the maximum output power and deliver the first control signal to the first switch when the first voltage exceeds a second voltage, such that the core system is powered by the rechargeable battery and the constant power adapter at the same time.

5. The electronic system as claimed in claim 4, wherein when the requirement power exceeds the maximum output power and the capacity of the rechargeable battery is lower than the first predetermined value, the embedded controller enables the rechargeable battery to stop supplying power to the core system, and delivers a power management signal to the core system, such that the electronic device decreases the requirement power.

6. The electronic system as claimed in claim 5, wherein the charger is coupled between the core system and the constant power adapter to provide the charge power to the core system and the rechargeable battery.

7. The electronic system as claimed in claim 6, further comprising:
a second switch, coupled between the rechargeable battery and the charger, and configured to enable the charge power to stop powering the rechargeable battery according to a second control signal of the control unit when the requirement power exceeds the maximum output

8. A power management method, suitable for an electronic device powered by a constant power adapter, the electronic device comprising a core system, a rechargeable battery, a charger, and a control unit, and the power management method comprising:
identifying whether a requirement power of the electronic device exceeds a maximum output power of the constant power adapter;
detecting whether a capacity of the rechargeable battery exceeds a first predetermined value, when the requirement power of the electronic device exceeds the maximum output power of the constant power adapter; and
enabling the rechargeable battery and the constant power adapter to power the core system at the same time when the capacity of the rechargeable battery exceeds the first predetermined value.

9. The power management method as claimed in claim 8, further comprising:
delivering a power management signal to the core system when the requirement power exceeds the maximum output power and the capacity of the rechargeable battery is lower than the first predetermined value, such that the electronic device decreases the requirement power.

10. The power management method as claimed in claim 8, further comprising:
delivering a power management signal to the core system when the requirement power exceeds the maximum output power and the capacity of the rechargeable battery is lower than a second predetermined value, such that the electronic device decreases the requirement power, wherein the second predetermined value is less than the first predetermined value.

11. The power management method as claimed in claim 8, further comprising:
enabling the charger to stop powering the rechargeable battery, when the requirement power exceeds the maximum output power of the constant power adapter.

12. The power management method as claimed in claim 8, further comprising:
detecting an output current provided to the electronic device, wherein the output current is supplied by the constant power adapter;
generating a first voltage corresponding to the output current; and
determining that the requirement power exceeds the maximum output power when the first voltage exceeds a second voltage.

13. The power management method as claimed in claim 8, wherein the step of powering the core system by the constant power adapter and the rechargeable battery at the same time comprises:
converting the power provided by the constant power adapter into a charge power, and supplying the charge power to the core system;
stopping powering of the rechargeable battery by the charge power; and
providing the power of the rechargeable battery to the core system.

14. The power management method as claimed in claim 8, wherein the step of powering the core system by the constant power adapter and the rechargeable battery at the same time comprises:
providing the power provided by the constant power adapter to the core system and the charger;
stopping powering of the rechargeable battery by the charge power; and
providing the power provided by the rechargeable battery to the core system.

15. An electronic device, powered by a constant power adapter, comprising:
a core system, configured to control operations of the electronic device;
a rechargeable battery;
a control unit, configured to detect whether a capacity of the rechargeable battery exceeds a first predetermined value when a requirement power of the electronic device exceeds a maximum output power of the constant power adapter, and to enable the rechargeable battery and the constant power adapter to power the core system at the same time when the capacity of the rechargeable battery exceeds the first predetermined value.

16. The electronic device as claimed in claim 15, wherein the control unit comprises:
a current detector, configured to detect an output current which is provided to the electronic device by the constant power adapter and generate a first voltage corresponding to the output current; and
an embedded controller, configured to determine that the requirement power exceeds the maximum output power and to enable the constant power adapter and the rechargeable battery to power the core system at the same time, when the first voltage exceeds a second voltage.

17. The electronic device as claimed in claim 16, wherein the embedded controller enables the rechargeable battery to stop powering the core system and delivers a power management signal to the core system when the requirement power exceeds the maximum output power and the capacity of the rechargeable battery is lower than the first predetermined value, such that the electronic device decreases the requirement power.
